(19) United States
(12) Patent Application Publication
(10) Pub. No.: US 2025/0129517 A1
(43) Pub. Date: Apr. 24, 2025

(54) COMPOSITIONS AND METHODS OF THERMAL CONTROL AND ENERGY STORAGE IN COMPOSITE POLYMER YARNS VIA STRAIN-INDUCED PHASE TRANSITIONS

(71) Applicant: Massachusetts Institute of Technology, Cambridge, MA (US)

(72) Inventors: Svetlana V. Boriskina, Winchester, MA (US); Jungwoo Shin, San Jose, CA (US); Volodymyr Korolovych, Boston, MA (US); Duo Xu, Cambridge, MA (US); Hannah Gold, Cambridge, MA (US); Buxuan Li, Guaynabo, PR (US); You Lyu, Cambridge, MA (US)

(21) Appl. No.: 18/922,376

(22) Filed: Oct. 21, 2024

Related U.S. Application Data
(60) Provisional application No. 63/545,155, filed on Oct. 20, 2023.

(51) Int. Cl. D01D 5/10; D01D 5/098; D01F 1/10; D01F 6/30; D02G 3/44

(52) U.S. Cl. CPC D01D 5/10; D01D 5/098; D01F 1/10; D01F 6/30; D02G 3/44

(57) ABSTRACT

Compositions and methods for forming composites of polymer fibers, yarns, and textiles having enhanced elastocaloric and twistocaloric performance are provided herein. The composites can permit reversible temperature shifts within the materials, and can be used, for example, in energy conversion and thermal storage systems. These composites can be formulated by melt spinning the polymer fibers and using combinations of twisting and stretching of the polymer fibers. The fibers can include, for example, a base polymer that can be amorphous, or substantially amorphous, and desired alignment can occur, for example, by performing one or more of the various provided for techniques. In at least some embodiments, the composite materials can be further enhanced by including one or more phase change materials (PCMs), such as by cross-linking the one or more PCMs with one or more polymers and/or directly attaching the PCM(s) to the polymer(s).

### CROSS REFERENCE TO RELATED APPLICATION

The present disclosure claims priority to U.S. Provisional Application No. 63/545,155, entitled “Thermal Control and Energy Storage in Composite Polymer Yarns Via Strain-Induced Phase Transitions” which was filed on Oct. 20, 2023, and which is incorporated by reference herein in its entirety.

### GOVERNMENT RIGHTS

This invention was made with government support under DE-FG02-02ER45977 awarded by the U.S. Department of Energy, and W911NF-13-D-0001 awarded by the U.S. Army Research Office. The government has certain rights in the invention.

### FIELD

The present disclosure relates to composite polymer fibers, yarns, and textiles having enhanced elastocaloric and twistocaloric performance that permit reversible temperature shifts within the materials, and can be used, for example, in energy conversion and thermal storage systems. Further, the present disclosure more particularly relates to methods of forming such fibers, yarns, and textiles, and then implementation of the same, resulting in sustainable products that still maximize performance.

### BACKGROUND

Residential thermal management (i.e., heating and refrigeration), which operates at low efficiency (below 60%) and contributes significantly to greenhouse gas emissions, is one of the most energy-intensive technology sectors. In 2021, space cooling alone accounted for nearly 16% of final electricity consumption in the buildings sector globally (approximately 2,000 TWh), while the direct CO₂ emissions from space and water heating reached a record high of 2.5 G tons in 2021. Leakage of one kilogram of vapor compression refrigerant to the atmosphere is equivalent to two tons of CO₂ in global warming potential, which leads to high-GWP refrigerants such as Freon® to be phased out via regulatory requirements. The residential heating, ventilation and air-conditioning (HVAC) units fabricated after 2020 use chlorine-free hydrocarbon refrigerants, e.g., Puron®, etc. Unfortunately, many of these new GWP-low refrigerants are mildly flammable and require more training and safeguards for HVAC technicians to be able to work with them efficiently.

Replacing conventional HVAC technologies with solid-state alternatives based on magnetocaloric (MC), electrocaloric (EC), and mechanocaloric (mC) effects holds promise to engineer compact, low-noise, gravity-independent, and potentially highly reliable systems with increased cooling efficiency and reduced emissions. Caloric effects are manifested by temperature (ΔT) and entropy (ΔS) changes in solid materials triggered by an adiabatic change of an external stimulus. EC and MC effects stem from the entropy exchange between the vibrational and either dipolar or magnetic spin subsystems, respectively, under external electromagnetic fields. In turn, mC effects are typically associated with entropy changes caused by the crystal structure transformations between high- and low-symmetry phases (e.g., amorphous to crystalline or orthorhombic to monoclinic), and—depending on the type of mechanical deformation—are classified as elasto- (eC), twisto- (tC), baro- (bC), flexo- (fC), and shear-caloric (sC). To date, the largest values of ΔT and ΔS have been reported in elastocaloric shape memory alloys (SMAs), which can exhibit a latent heat of martensitic transformation as large as 35100 J/kg, and temperature variations up to 87.8 K. However, elastocaloric SMAs such as Ni—Ti, Ni—Mn—Ti, Ti—Ni—Cu—Al, Ni—Fe—Ga—Co, Fe—Pd, and Cu—Al—Ni fail to reach commercial adoption due to their high cost and weight, use of non-abundant elements, and a very large stress (up to 500 MPa) that may be required to trigger the phase change.

Polymers offer promise as soft, lightweight, and cheap alternative mC materials, which require low-force activation, comparable to that of the state-of-the-art vapor-compressors and two orders of magnitude lower than that for SMAs. While ΔT values exceeding 10 K have been demonstrated in natural rubber (NR, cis-1,4-polyisoprene), isoprene and chloroprene rubbers, and thermoplastic polyurethanes (TPU), engineering of mC polymers has been plagued by a different set of challenges, including very large actuating deformations, poor cycling stability and generation of non-recyclable waste. All these challenges stem from the underlying physics of the mC effect in conventional mC elastomers like NR, i.e., polymer chains alignment upon stretching, which decreases their conformational entropy and promotes partial crystallization of amorphous chains into a crystalline state. The crystallization process is typically triggered at a large strain level (over 300% for NR at room temperature), hindering the use of these polymers in compact solid-state heat pumps and cooling systems.

Recent work has demonstrated that block co-polymers (e.g., SEBS) composed of alternating soft and hard segments, can exhibit a large ΔT in mC effects, which may be driven by the entropy change associated with uncoiling and alignment of their soft segment, without stress-induced crystallization. However, these block co-polymers can require both large elongation ratios and relatively large mechanical stresses for actuation. As a separate challenge, most chain coiling-uncoiling mC elastomers explored to date are highly cross-linked thermosets and thus cannot be mechanically recycled at the end of their lifecycle, contributing to the growing plastic waste problem.

Accordingly, there is a need for improved materials for use in energy conversion and thermal storage systems that offer sustainability without sacrificing performance.

### SUMMARY

The present application is directed to replacement of conventional heating, ventilation, and air conditioning (HVAC) technologies with solid-state mechanocaloric alternatives. These alternatives, which can include composite materials, such as fibers, yarns, and textiles, which can be comprised of elastocaloric and twistocaloric polymer fibers can increase their energy efficiency and reduce greenhouse gas emissions. State-of-the-art mechanocaloric metal shape-memory alloys can have high cost and require high actuating forces, while cross-linked polymer thermosets exhibit large actuating deformations, poor cycling stability, and generate non-recyclable waste. In some embodiments, olefin block co-polymer (OBC) elastomer fibers can be used as an alternative due to its promising high-performance, durable, and recyclable mechanocaloric features, which are capable of operating across a wide range of ambient temperatures. For example, OBC fibers can exhibit a temperature jump over 20° C. in the first actuation cycle, with well-trained fibers demonstrating stable operation for at least a thousand cycles with a material coefficient of performance (COP) as high as 8, depending on the actuation process and ambient temperature. Using comprehensive mechanical-thermodynamic theory, the mechanocaloric effects in OBC fibers can be shown to be driven by the entropy change caused by molecular chain alignment under strain, rather than by the strain-induced crystallization effect underlying mechanocaloric performance of cross-linked rubbers. Then, using this developed fundamental understanding of the mechanocaloric effects in OBC fibers, further performance improvements and discovery and/or synthesis of new high-performance mechanocaloric polymers can be achieved.

One example embodiment of a process for forming a composite includes melt spinning a plurality of materials and performing a combination of one or more of twisting, braiding, knotting, or stretching deformations of the plurality of materials to produce a composite configured to have reversible temperature shifts stored in the composite. The plurality of materials is at least one of elastocaloric or twistocaloric.

The plurality of material can include one or more olefin block co-polymers. In some embodiments, the process can include cross-linking the plurality of materials by irradiation with one or more of electron beams, X-rays, or gamma-rays. One or more phase change materials can be coupled to the plurality of materials. Coupling one or more phase change materials to the plurality of materials can include doping the plurality of materials with one or more phase change materials. In some embodiments, coupling one or more phase change materials to the plurality of materials can further include directly attaching the one or more phase change materials to the plurality of materials. The plurality of materials can include one or more amorphous co-polymers and/or substantially amorphous co-polymers.

In some embodiments, the composite material can be environmentally friendly and/or sustainable. An activation energy for forming the composite material can be at least one order of magnitude lower than a known activation energy for forming comparable composite materials that lack the plurality of materials.

In some embodiments, performing the combination of one or more of twisting, braiding, knotting, or stretching deformations of the plurality of materials to produce a composite material configured to have reversible temperature shifts stored in the composite can further include adjusting at least one of: a speed of deformation, a number of times a deformation is performed, a temperature, a type of deformation, and/or a level of deformation to alter properties of the resulting composite material. The process can be devoid of strain-induced crystallization. In some embodiments, a dopant can be added to the plurality of materials. Adding the dopant can include spin-doping the material with one or more magnetocaloric or electrocaloric materials. The dopant can include at least one of nano-scale phase-separated inclusions and/or micro-scale phase-separated inclusions in a matrix of the plurality of materials. The plurality of materials can be substantially devoid of cross-links.

One example of a method of providing at least one of energy conversion or energy storage includes using a composite material that includes a plurality of melt-spun materials that are at least one of elastocaloric or twistocaloric, and underwent at least one of twisting or stretching deformations, in conjunction with at least one of a heat pump, a refrigeration system, a rechargeable hot-cold bandage, or a blanket.

The composite material can include a fiber and/or yarn. Further, at least one of the fiber and/or yarn can have a phase-change material coupled to it.

One example of a composite includes a thermoplastic block co-polymer having a plurality of at least one of melt-spun elastocaloric or twistocaloric materials that have reversible temperature shifts stored in the materials after a combination of at least one of twisting or stretching deformations of the at least one of melt-spun elastocaloric or twistocaloric materials.

The composite can be substantially devoid of cross-links. The thermoplastic block co-polymer can include one or more olefin block co-polymers. At least 90 wt % of the thermoplastic block co-polymer can be in amorphous phase. A mechanocaloric temperature change of the material between its fully relaxed configuration and its fully deformed configuration can be approximately in a range from about 1.5° C. to about 30° C. A Young's Modulus of the material can depend on a temperature in which the thermoplastic block co-polymer is disposed. The thermoplastic block co-polymer can have a glass transition temperature approximately in a range of about 0° C. to about −30° C. In some embodiments, the composite can include at least one of nano-scale phase-separated inclusions and/or micro-scale phase-separated inclusions in a matrix of the thermoplastic block co-polymer.

### BRIEF DESCRIPTION OF DRAWINGS

This disclosure will be more fully understood from the following detailed description taken in conjunction with the accompanying drawings, in which:

FIG. 1A is a schematic of perspective views of example embodiments of a fiber melt-spun from an olefin block co-polymer (OBC), which may contain nano- and/or micro-inclusions from at least one phase-change material (PCM);

FIG. 1B is a photograph of top perspective views of example embodiments of braided structures composed from the OBC fibers of FIG. 1A;

FIG. 2 is a top view of a prior sample of olefin block co-polymers (OBC) pellets used to make the fibers of the composite materials of the present embodiments;

FIG. 3A is perspective view of one embodiment of a home-built stretch-twist coupled stage that can be designed to characterize mechanocaloric (mC) effects in fibers subjected to mechanical deformations;

FIG. 3B is a graph illustrating an example OBC fiber temperature evolution captured by an infrared camera during a mechanocaloric cycle with an inset (1) showing a melt-spun OBC fiber;

FIG. 3C is a schematic illustration of crystallizable linear polyethylene (PE) blocks (hard segments), alternating with amorphous blocks with high octene content in the ethylene chain (soft segment) that make up the OBC fiber of FIG. 3B;

FIG. 3D is a schematic illustration of OBC polymer chain configurations of the OBC fiber of FIG. 3B before (i.e., pristine state) and after stretching (i.e., strained state);

FIG. 3E illustrates infrared (top) and optical microscope (bottom) images of the OBC fiber of FIG. 3B in its pristine state;

FIG. 3F illustrates infrared (top) and optical microscope (bottom) images of the OBC fiber of FIG. 3B in its stretched state;

FIG. 3G illustrates infrared (top) and optical microscope (bottom) images of the OBC fiber of FIG. 3B in its twisted state;

FIG. 3H is a graph illustrating measured mC performance of the OBC fiber of FIG. 3B under uniaxial stretching in comparison to values reported for other mC polymers mC (mechano-caloric) polymers;

FIG. 3I is a graph illustrating measured mC performance of the OBC fiber of FIG. 3B under twisting of a pre-stretched fiber as a function of fiber strain/pre-strain in comparison to values reported for other mC polymers;

FIG. 4A is a graph illustrating volume average heating and cooling temperature differences for 1000 cycles of uniaxial stretching deformations up to about 300% maximum strain;

FIG. 4B is a graph illustrating volume average temperature differences for 1000 cycles of twisting deformations applied to a fiber with about 300% pre-strain up to about 0.9 turn/mm;

FIG. 4C is a graph illustrating cooling performance of the performance of OBC fibers under cyclic uniaxial stretching deformations approximately in the range from about 100% to about 300% for (A) the cooling temperature difference ΔT_{C}, (B) net work input per cycle calculated from the loading/unloading hysteresis curve, and (C) the coefficient of performance (COPₘₐₜ) for the eC fiber performance over 50 cyclic loadings;

FIG. 4D is a graph illustrating cooling performance of the performance of OBC fibers under cyclic twisting deformations for maximum strains approximately in the range from about 100% to about 300% for (D) the cooling temperature difference ΔT_{C}, (E) net work input per cycle calculated from the loading/unloading hysteresis curve, and (F) the coefficient of performance (COPₘₐₜ) for the eC fiber performance over 50 cyclic loadings;

FIG. 5 is a graph illustrating temperature differences (ΔT_{H} and −ΔT_{C}) of well-trained OBC fibers twisted up to the fully coiled state (about 0.9 turns/mm for fiber with initial diameter about 2.2 mm) with pre-strains approximately in the range from about 100% to about 400%;

FIG. 6 is a graph illustrating stress-strain hysteresis curves for the OBC fibers melt-spun under different process parameters of the present embodiments;

FIG. 7A is a set of infrared images illustrating the temperatures with respect to crystallinity, specific heat, and stress-strain hysteresis curves for the OBC fibers melt-spun under different process parameters of the present embodiments;

FIG. 7B is a graph illustrating heating and cooling temperatures achieved by uniaxial stretching to a different draw ratio;

FIG. 7C is a graph illustrating heating and cooling temperatures achieved by the fiber twisting process with varying twisting density;

FIG. 7D is a graph illustrating temperature differences achieved under different operational scenarios and combinations of the present embodiments;

FIG. 7E is a graph illustrating temperature differences achieved under stretching actuation of one of the braided structure embodiments;

FIG. 8 is a table comparing polymer types and their corresponding heating ΔT values under uniaxial stretching deformation;

FIG. 9 is a table comparing the mechanocaloric performance of various polymer materials and the actuation force needed to achieve mechanical deformation;

FIG. 10A is a graph summarizing different families of PCM materials that can be combined with the mechanocaloric polymers into composite materials for heat storage applications;

FIG. 10B is a table and graph summarizing organic carbohydrate PCMs with varying heat of fusion and phase transition temperatures;

FIG. 11A is a perspective view of the OBC elastocaloric fiber of FIG. 1A having a first thermochromic pigment embedded therein during a melt-spinning process in its unstretched state; and

FIG. 11B is a perspective view of the fiber of FIG. 11A having a second thermochromic pigment induced by the stretch-induced heating effect in its stretched state.

### DETAILED DESCRIPTION

Certain exemplary embodiments will now be described to provide an overall understanding of the principles of the structure, function, manufacture, and use of the compositions and methods disclosed herein. This includes in the description and claims provided for herein. Further, one or more examples of these embodiments are illustrated in the accompanying drawings. Those skilled in the art will understand that the compositions and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure. The present disclosure includes references to non-limiting, exemplary materials (e.g., fibers, yarns, braided structures, and textiles with or without PCM inclusions) formulated in conjunction with the disclosures and teachings herein, that were used in conjunction with arriving at the present disclosures. A person skilled in the art, in view of the present disclosures, will understand that these materials are non-limiting examples and have properties as provided for in, and/or derivable from, the present disclosures.

The present disclosure is generally directed to composite materials, such as fibers, yarns, and textiles that can be comprised of elastocaloric and twistocaloric polymer fibers, as well as, in at least some instances, phase change materials. The resulting composite materials can be used for solid-state, strain-activated energy conversion and thermal storage systems. The disclosure provides for various techniques that can be employed to formulate such composite materials, such as melt spinning the polymer fibers and using combinations of twisting and stretching of the polymer fibers (e.g., polyethylene and/or other materials known to perform in a similar manner). The fibers can include, for example, a base polymer that can be amorphous, or substantially amorphous, and desired alignment can occur, for example, by performing one or more of the various provided for techniques. In at least some embodiments, the composite materials can be further enhanced by including one or more phase change materials (PCMs), such as by doping one or more polymers with one or more PCMs with and/or directly attaching the PCM(s) to the polymer(s). The resulting materials can have elastocaloric and twistocaloric performance that rival existing materials, while also being durable and sustainable (e.g., environmentally friendly). The activation energy (as illustrated in greater detail in FIG. 9 below) needed to formulate such materials is significantly less than the formation of conventional comparable-performing materials, and resulting temperature ranges for purposes of being able to generate and/or store energy are comparable and/or better than that of these conventional materials. Moreover, an equivalency between uniaxial stretching and fully-coiled twisting deformations of amorphous OBC fibers of the present embodiments presents a comprehensive temperature-dependent mechanical-thermodynamic theory to explain their entropy change and unconventional non-monotonic temperature dependence of ΔT. Further mC performance improvements of thermoplastic elastomers, which can be achieved via their partial cross-linking to find the optimal balance between cooling/heating efficiency and recyclability ca be used to optimize the performance of the materials of the present embodiments. The materials provided for herein can be used in conjunction with and/or in lieu of conventional HVAC refrigeration processes, heat pumps, and/or rechargeable hot-cold bandages and blankets, to name a few uses, providing more environmentally-friendly, solid-state energy production and/or storage options.

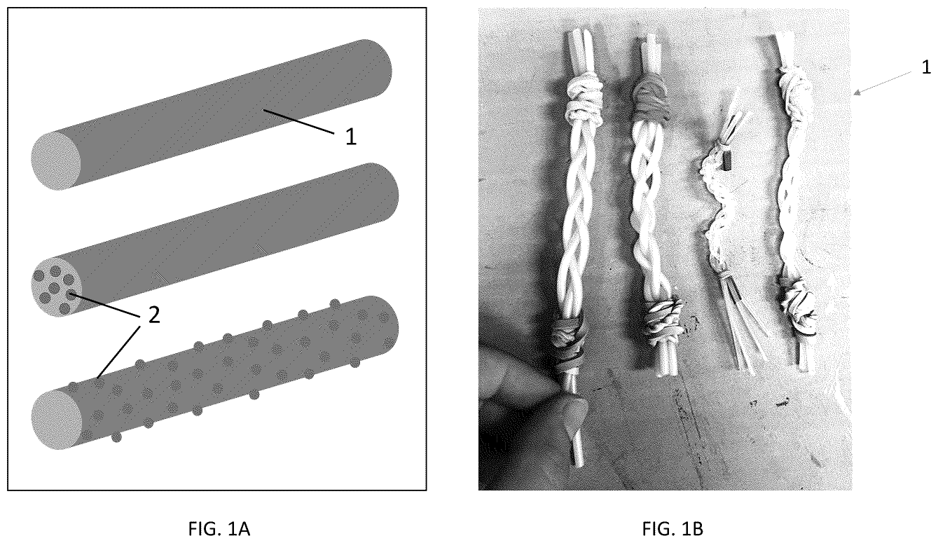

FIGS. 1A-1B illustrate an embodiment of a fiber, or composite 1 of the present embodiments. The composite 1 can include OBC polymer comprising hard and soft segments with side branches, with crystallinity in its pristine state that is lower than about 20% and ideally not exceeding 5%. These materials can be thermoplastic, elastic without cross-linking, and have large entropy change between stretched and relaxed states, which can be observed by a large temperature dependence of the Young's modulus and/or predicted via ab-initio modeling using density functional theory (DFT) methodology. Moreover, the material can have low glass transition temperature (a range for which is provided below) and lightly cross-linked by irradiation with electron beams, X-rays or gamma-rays, are cheap and produced commercially on scale. The composite materials of the present embodiments can include fibers, yarns, and textiles that can be comprised of elastocaloric and twistocaloric polymer fibers, as well as, in at least some instances, polymer fibers combined with phase change materials (PCMs). The polymers can be doped and/or decorated by PCM nanomaterials, including paraffins, liquid crystals, liquid metals, magnetocaloric materials (such as e.g., gadolinium micro/nano-particles), electrocaloric materials (such as e.g., perovskites, thermochromic pigments and dyes), metal organic frameworks (MOFs), etc. The PCM-enhanced polymer composites can be melt-spun into fibers and yarns that can allow for operation in a broad temperature range relevant to HVAC operational conditions. Examples of embodiments of braided structures composed from OBC fibers of the present embodiments are shown in FIG. 1B.

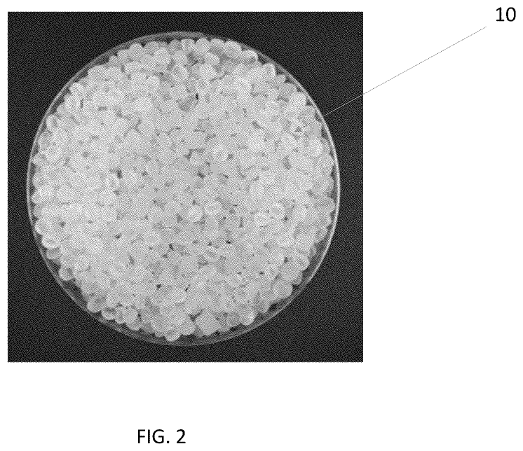

The composition of the material can vary. In some embodiments, the material can be a thermoplastic amenable to melt-spinning into a fiber form, exhibiting good elastic recovery upon stretching to 4-10 times its initial length. In some embodiments, these elastocaloric and twistocaloric polymer fibers can be made of olefin block co-polymers (OBC), which is a new family of high-performance, durable, and recyclable crystallization-free mC elastomers that can operate across a wide temperature range from about +60° C. to at least about −20° C. The fibers of the present embodiments can be made from pellets of OBC 10, e.g., INFUSE 9100 OBC pellets from DOW Chemical company, an example of which are shown in FIG. 2. These pellets can be fed into an extruder and prepared by a conventional melt-spinning process as discussed in greater detail below. Some additional examples of the materials used to make the composite of the present embodiments can include TAFMER® resins available from Mitsui Chemicals America, Inc. (Rye Brook, NY) (e.g., TAFMER® DF110 and TAFMER® DF605 ethylene/unsaturated olefin copolymers), as well as ENGAGE® and other INFUSE® resins available from The Dow Chemical Company (Midland, MI).

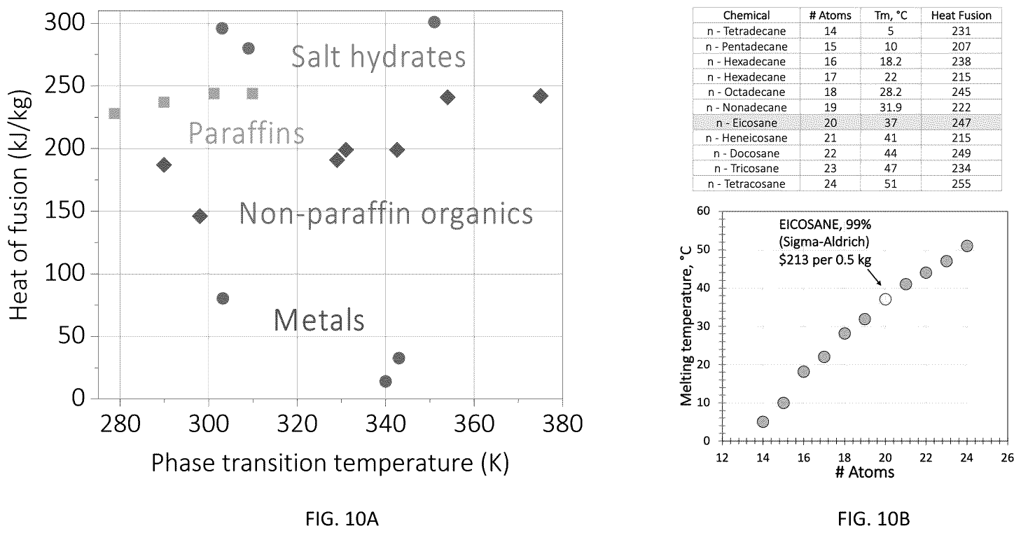

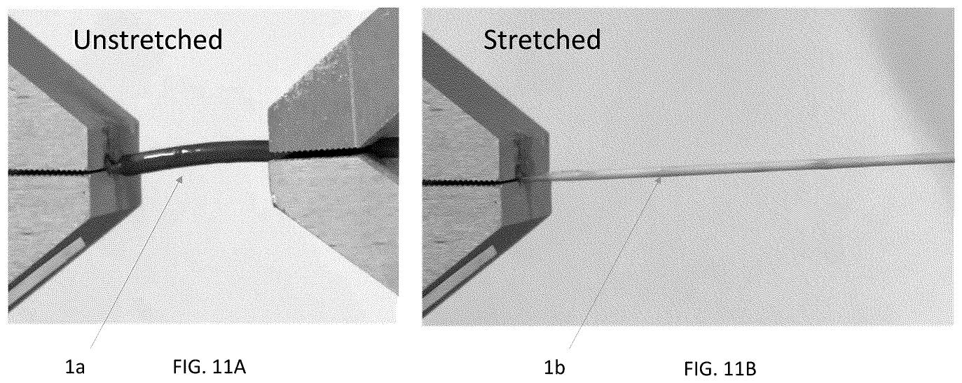

In some embodiments, the fiber 1 may include nano-and/or micro-inclusions 2 from at least one phase-change material (PCM), as shown in FIG. 1A. Further, as also shown in FIG. 1A, in at least some embodiments, PCM micro- or nano-particles 2 can be attached to the fiber surface. As mentioned above, one or more phase change materials (PCMs) can be coupled to the polymer fibers to promote enhancement of the fiber thermal and/or caloric performance. The coupling can occur, for example, via one or more of doping the fiber with one or more PCMs and/or directly attaching the PCM(s) to the fiber surface. In some embodiments, such as to enable multi-caloric operation, the material can be spin-doped with other caloric materials (e.g., magnetocaloric or electrocaloric), which may be incorporated as nano/micro-scale phase-separated inclusions in the base polymer matrix. Some non-limiting example PCM candidates that can be used for heat storage in composite mechanocaloric fibers are summarized further below in FIGS. 10A and 10B. PCM candidates that can be used to achieve multi-caloric effects under a combination of mechanical and non-mechanical (magnetic, electric, etc. stimuli) can include: magnetocaloric materials such as, for example, gadolinium micro/nano-particles, electrocaloric materials, e.g., perovskites, metal organic frameworks (MOFs), etc. PCMs candidates that can be used to induce changes in the fiber structure or appearance triggered by elastocaloric temperature increase or drop include liquid crystals as well as thermochromic pigments and dyes (see FIGS. 11A-11B, and related descriptions, below).

The mC effects in OBC fibers fabricated by melt-spinning can be optimized in a variety of ways. OBCs are mass-produced thermoplastic polymers, and are promising candidates for applications in mC-based solid-state heating/cooling owing to their superb mechanical properties, including high elasticity, light weight, and chemical inertness. OBCs have low material cost and excellent recyclability because of their extremely low glass transition temperature and cross-link free nature. For the purposes of this disclosure, low glass transition temperature can refer to termperatures approximately in a range of about 0° C. to about −30° C. These parameters can allow for operation in a broad temperature range that is relevant to HVAC operation conditions. Therefore, OBCs have one of the lowest environmental footprints for fiber production among conventional natural and synthetic polymers.

In an attempt to reduce the mC polymer actuation deformation range, twisting can be proposed as an alternative to uniaxial stretching, via a phenomenon known as the twistocaloric effect. It will be appreciated that mC effects with ΔT up to about 13 K have been unlocked in semicrystalline polymers such as e.g., nylon and polyethylene by application of twisting-induced torsional stress. Twistocaloric effect in semi-crystalline materials can be driven by the first-order phase transition, e.g., from orthorhombic to monoclinic phase in polyethylene, which, similar to shape memory alloys (SMAs), can use large mechanical energy for actuation. Application of the twisting deformation to fibers made from natural rubber (NR) and other elastomers has been shown to also trigger mC effects, which were classified as twistocaloric and attributed to the change in entropy of the material driven by torsional stress. The olefin block co-polymers (OBCs) of the present embodiments can function as a new family of high-performance, durable, and recyclable crystallization-free mC elastomers that can operate across a wide temperature range, appriximately in a range from about +60° C. to at least about −20° C.

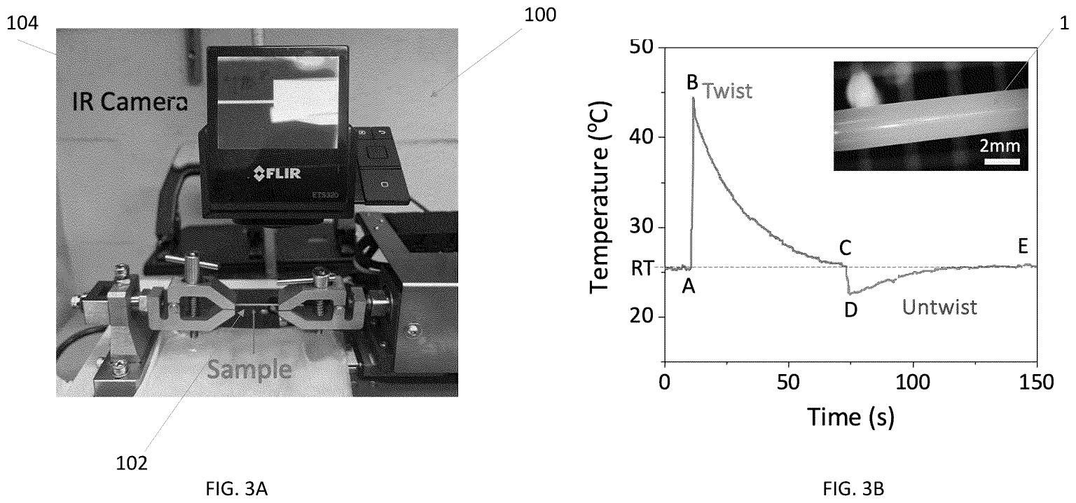

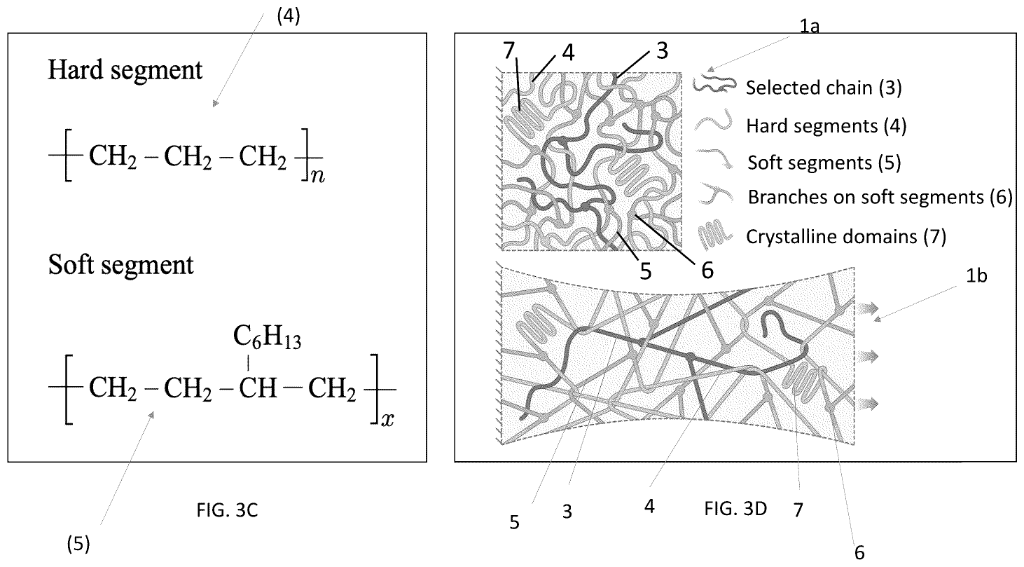

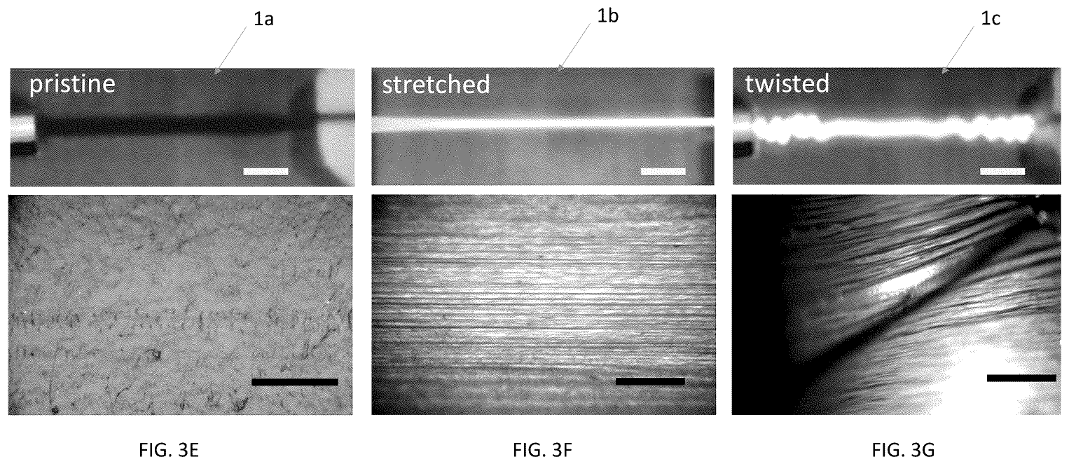

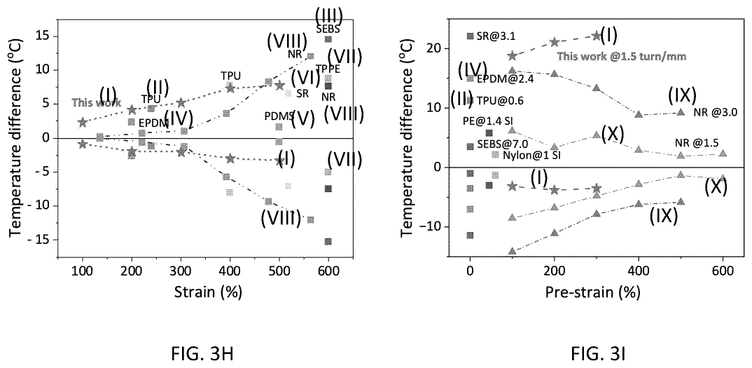

FIG. 3A illustrates one embodiment of a home-built stretch-twist coupled stage 100 that can be designed to characterize mechanocaloric (mC) effects in fibers subjected to mechanical deformations, including uniaxial stretching, twisting, and combinations thereof. That is, the mC effects in elastic amorphous OBC fibers can be measured using the stage. As shown, the adiabatic in-situ temperature responses of fibers in a sample 102 can be captured by an infrared (IR) camera 104 during the stretch/twist insertion/removal processes. FIG. 3B illustrates an example OBC fiber temperature evolution captured by the IR camera during a mechanocaloric cycle, in which a fiber with about 200% pre-strain is twisted up to a maximum twist density of about 1.2 turn/mm, followed by a twist release. It will be appreciated that fiber twisting may be preferred when aiming to achieve a compact system design due to its ability to generate a deformation similar to or larger than stretching and is more convenient for device operation. Notably, as per the methods of the present embodiments, pre-strain can be an effective way of engineering fibers for optimum mC performance under twisting deformations.

During the twist insertion stage (from point A to point B), the surface temperature can increase from ambient value of Tₐ=about 25.2° C. to T_{H}=about 44.5° C., which can exhibit an adiabatic temperature difference of T_{H}−Tₐ=about 19.3° C. The twisted fiber can then reach an equilibrium with the environment via an exothermic process (B to C). Moreover, during the twist removal process (from C to D), the fiber can undergo an adiabatic cooling and its surface temperature can drop to T_{C}=about 22.3° C., achieving an adiabatic temperature difference of T_{C}−Tₐ=about −2.9° C. Finally, the fiber can return to its initial state (D to E), reaching an equilibrium with the ambient environment. The magnitude of the temperature difference for heating and cooling is denoted as ΔT_{H}=|T_{H}−Tₐ| and ΔT_{C}=|T_{C}−Tₐ| hereafter.

To compensate for the entropy reduction acompanying polymer chains stretching and formation of a higher-order structure, the material of FIG. 3B can undergo spontaneous heating, which is followed by a temperature drop below ambient upon deformation release. If the PCM inclusions are present in either of the fiber volume or on its surface, they in turn may undergo phase change transition triggered by the mechanocaloric temperature changes of the fiber.

The inset (i) of FIG. 3B illustrates a melt-spun OBC fiber 1 of the present embodiments with a diameter of about 2.2 mm. OBC resin can include crystallizable linear polyethylene (PE) blocks (hard segments) (4), alternating with amorphous blocks with high octene content in the ethylene chain (soft segment) (5), as shown in FIGS. 3C-3D. The elasticity of cross-links-free thermoplastic OBC fibers can be enabled by the entanglement between branched polymer chains, which can differ from conventional mC thermoset rubber elastomers.

FIG. 3D illustrates schematics of OBC polymer chain configurations before and after stretching. As shown, in its pristine state, an OBC fiber 1a can have a low concentration of scattered crystalline domains, which are embedded in its dominant amorphous matrix. The majority of the chains are in the amorphous state, with the side branches both preventing hard segments from crystallization and providing chain entanglement. The percentage of crystallite regions in the material can be at least lower than about 20%, and, in some embodiments, lower than 5%. Deformations can cause the amorphous chains stretching and alignment along the fiber axis, with side branches providing elasticity. That is, upon stretching, the already low fiber crystallinity can decrease further, while the amorphous chain orientation and alignment along the strain direction can be increased, as illustrated by a select chain stretching (3) in the strained configuration 1b.

FIGS. 3E-3G show the infrared (top) and optical microscope (bottom) images of the fiber in its pristine state (FIG. 3E), stretched state (FIG. 3F), and twisted state (FIG. 3G), respectively, with significant temperature changes are observed under deformation. For example, the microscopic images in FIGS. 3E-3G show increased alignment of amorphous polymer chains along the strain direction. Moreover, in the fully-coiled fiber configuration 1c, the mechanical deformation can be equivalent to that of uniaxial stretching. Under large deformations, fiber buckling may be inevitable due to the large length-to-diameter ratio of the OBC fibers, and the equivalency between stretching and twisting-coiling actuation processes can allow for achieving the same high level of fiber elongation in a significantly reduced device footprint.

FIGS. 3H-3I compare the adiabatic temperature difference of an OBC fiber measured during the first deformation cycle (illustrated as stars in the graph) with the corresponding values previously reported for other polymers. Specifically, FIG. 3H illustrates measured mC performance of an OBC fiber under uniaxial stretching in comparison to values reported for other mC polymers, while FIG. 3I illustrates measured mC performance of an OBC fiber under twisting of a pre-stretched fiber as a function of fiber strain/pre-strain in comparison to values reported for other mC polymers. Some non-limiting examples of the other mC polymers can include styrene ethylene butylene styrene (SEBS), (C₈H₈)ₙ—(C₆H12)ₘ—(C₈H₈)ₙ, Polydimethylsiloxane (PDMS), natural rubber (NR) (C₅H₈)n, synthetic rubber (SR), (3) cis-butadiene rubber (CBR) (C₄H₆)ₙ, thermoplastic polyurethane _{(TPU)} [—OC(O)—R—NH—C(O)—O—R′—O—]ₙ, Ethylene Propylene Diene Terpolymer (EPDM) rubber, and/or Tris(diphenylphosphinomethyl)ethane (TPPE). As shown in FIG. 3H, the OBC fiber of the present compounds (I) is compared to TPU (II), SEBS (III), EPDM (IV), PDMS (V), SR (VI), TPPE (VII), and NR (VIII).

As shown in FIG. 3H, for elastocaloric (eC) effects, the OBC fiber can exhibit high values of ΔT_{H} and ΔT_{C} under moderate strain levels (<about 350%), up to about 6.0/2.5° C. for heating and cooling, respectively. The temperature change of the OBC fiber under small deformations (<about 200% strain/pre-strain) can exceed the state-of-the-art values reported for eC polymers. For higher strain levels, natural rubber (NR) (VIII) can show larger ΔT_{H} and ΔT_{C} owing to the onset of the strain-induced crystallization, with the transition clearly observed at about 300% strain level. One skilled in the art will recognize that a typical approach to engineering more compact mC systems based on strain-crystallizable polymers can be to pre-strain a fiber to the threshold of the onset of the strain-induced crystallization (e.g., using about a 400% pre-strained fiber, which is cyclically elongated by another about 400% up to about 800% total strain). Although fiber pre-strain can help to reduce the amount of strain needed to achieve the phase change onset in natural rubber, it can also limit the maximum temperature change and still require dynamic changes of the sample lengths up to about 400%.

Moderate-to-high values of ΔT_{H} and ΔT_{C} can be achieved in a broader range of polymers via a twistocaloric (tC) effect, although in most cases both a significant level of pre-strain and an extreme twisting deformation (with a large number of turns per mm) are present, leading to fiber super-coiling. FIG. 1I illustrates the OBC fiber of the present embodiments with about 1.5 turn/mm as well as NR at about 3.0 turn/mm (IX) and about 1.5 turn/mm (X). The OBC fiber 110 can exhibit an extra-large ΔT_{H} (over about 20.0° C.) in the first cycle when twisted with about 300% pre-strain, as shown in FIG. 1I, which is the highest ΔT_{H} reported for mC polymers. The first-cycle ΔT_{C} for cooling during twist removal can be about 4.0° C.

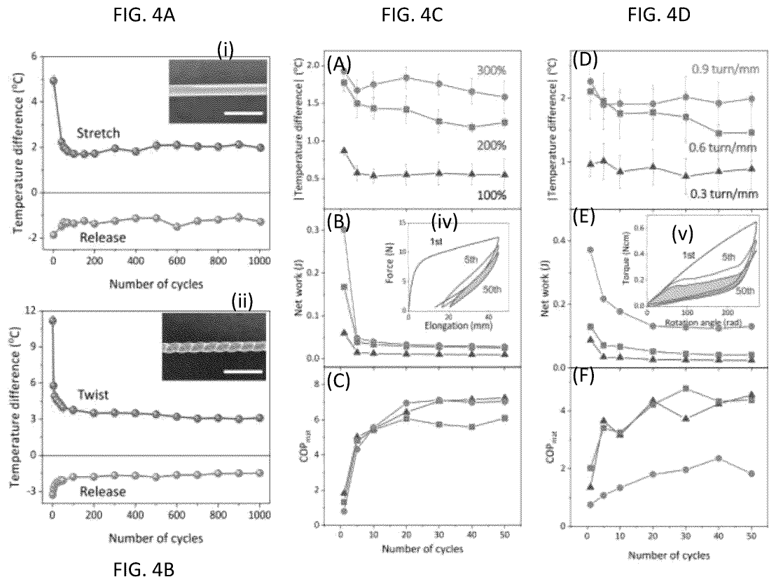

FIGS. 4A-4D show the cyclic stability of the mC performance of OBC fibers. Specifically, FIGS. 4A-4B illustrate volume average heating and cooling temperature differences for 1000 cycles of uniaxial stretching deformations up to about 300% maximum strain, and volume average temperature differences for 1000 cycles of twisting deformations applied to a fiber with about 300% pre-strain up to about 0.9 turn/mm, respectively.

As shown, the values of temperature difference that can be sampled every 10 cycles for the first 100 elasto-/twisto caloric cycles, and every 100 cycles in the interval between 100 and 1000 cycles, respectively. Moreover insets (i) and (ii) to FIGS. 2A-2B, respectively, can show a well-trained OBC fiber after 1000 cycles of stretching (twisting) up to about 300% strain (about 0.9 turns/mm twist insertion). During the first 100 cycles, ΔT_{H} and ΔT_{C} values of the OBC fibers can drop dramatically, which may be attributable to the Mullins effect, which manifests in irreversible deformations in polymers, including: (i) a deformation-induced stress-softening, (ii) a hysteresis (i.e., a difference between unloading and reloading paths) revealing the viscoelastic response of the material, and (iii) a residual strain at zero stress after unloading. After 100 cycles, when the samples are well-trained, the internal structure of the polymer can stabilize, and ΔT_{H} and ΔT_{C} (saturate at stable values of ΔT_{H}>about 2.0° C. and ΔT_{C}>about 1.7° C. for stretching, and ΔT_{H}>about 3.0° C. and ΔT_{C}>about 1.5° C. for twisting.

The material coefficient of performance for either heating or cooling (COP_{H,Cat}) can be defined as a ratio of the adiabatic internal energy change of OBC fibers under deformation and the mechanical work input needed to achieve such deformation:

$${COP}_{H , C} = \frac{\frac{Q}{m}}{\frac{Δ W}{m}} = \{ \begin{matrix}\frac{{\int }_{{T}_{a}}^{{T}_{H}} {c}_{p} ( T ) dT}{\frac{1}{m} ∮ F dl} & Heating , \\ \frac{{\int }_{C}^{{T}_{a}} {c}_{p} ( T ) dT}{\frac{1}{m} ∮ F dl} & Cooling .\end{matrix} \qquad ( 1 )$$

This figure of merit integrates the fiber specific heat cₚ over the temperature difference, either ΔT_{H} or ΔT_{C}, to quantify the heating or cooling internal energy change (Q/m) per unit mass. In turn, the input work per unit mass (ΔW/m) can be calculated by integrating either the strain-stress or the torque-rotation angle curve measured in the stretching and twisting processes.

As there is a higher demand for mC solid-state cooling technologies, FIGS. 4C-4D can analyze the cooling ΔT_{C} and COP_{C} measured in the well-trained samples. For example, FIG. 4C can show from the top down, (A) the cooling ΔT_{C}, (B) the net work input per cycle calculated from the loading/unloading hysteresis curve, and (C) the COP_{C} for the eC fiber performance over 50 cyclic loadings under different levels of maximum strain, namely about 100%, about 200%, and about 300%. ΔT_{C} can monotonically increase with maximum strain, owing to the larger entropy change under larger deformation. ΔT_{C} can decrease slightly as the samples are trained by going through more loading/unloading cycles. However, the net work used to induce the same deformation can decrease faster than the associated temperature difference with the increasing number of deformation cycles. As shown in the inset (iv) of the middle panel (B) of FIG. 4C, the strain-stress curve can have the largest hysteresis in the first cycle due to the Mullins effect, resulting in the largest net work applied during that cycle. For a well-trained sample, defined as a sample after 50 cycles of loading, the final eC cooling COP_{C} can reach a value of about 6.0 for a maximum strain of about 200%, and can exceed about 7.4 for maximum strains of about 100% and about 300%, on par with the previously reported eC cooling COP_{C} values for polymers.

Similarly, ΔT_{C} of a tC cycle shown in corresponding panels (D)-(F) of FIG. 4D can decrease and then stabilize once the sample is well trained. ΔT_{C} can increase with the increase of twist density. A steeper drop in the net work can be observed with sample training, resulting in the increase of COP_{C} for well-trained samples. For the tC performance of OBC fibers, the optimal cooling COP_{C} exceeding four (4) can be achieved at smaller twist densities because the net work can increase in a superlinear way with the twist density, while ΔT_{C} increases at a much slower rate.

### Structural Characterization of the Fibers

In crystalline shape memory alloys (SMAs) and most mC polymers, temperature responses upon deformation can be primarily caused by either the release of latent heat as a result of a phase change process (i.e., ferromagnetic phase transition for SMAs and strain-induced crystallization for NR), or a change in entropy, or a synergistic result of both effects. To determine the dominant mechanism underlying the observed eC and (twisto-caloric) tC effects in amorphous OBC fibers, wide-angle X-ray scattering (WAXS) and Raman spectroscopy have been used to examine variations in the fiber crystallinity, crystallographic phase transformations, and polymer chain alignment under stretch and twist loading.

### Mechanocaloric (mC) Effects on Temperature Dependence

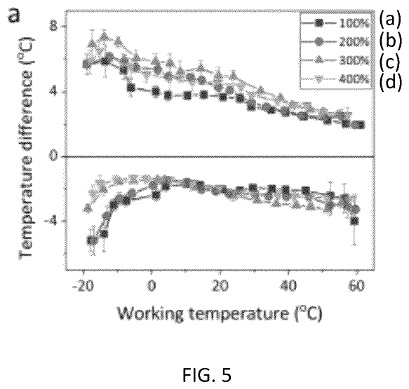

OBC fibers have a very low glass transition temperature, e.g., about −70° C. or about −80° C., offering opportunities to achieve strong mC effects at low temperatures. FIG. 5 illustrates the temperature dependence of OBC fibers tC response in a temperature range from about −20° C. to about +60° C. For example, FIG. 5 shows the heating/cooling temperature differences for well-trained samples twisted up to about 0.9 turns/mm, with pre-strain of about 100% (a), about 200% (b), about 300% (c), and about 400% (d). As shown, the temperature drop ΔT_{C} during the releasing process can reveal an unconventional non-linear temperature dependence for all four pre-strains. The ΔT_{C} value can be minimized near about 0° C. and increase with both increasing and decreasing working temperatures. The working temperature that minimize ΔT_{C} can move monotonically from about 5° C. at about 100% pre-strain level, to about −10° C. at about 400% pre-strain level. The temperature rise ΔT_{H} during the twisting process can exhibit a negative and almost linear dependence across this temperature range.

Compared to the reported state-of-the-art for cooling COP_{C}, amorphous elastic OBC fibers can occupy a niche position in the mC materials landscape, as they use very low stress to drive deformations yet can realize a competitive value of cooling COP_{C}. For example, OBC polymer fibers can use several orders of magnitudes less stress to induce the deformation than Ni—Ti alloys. The synthesis and fabrication cost of polymers per unit mass for OBCs is also two orders of magnitude lower. While the OBC fiber performance may still be below the highest COP_{C} reported in natural rubber in some embodiments, OBC fibers can provide a sustainable, environmentally stable, and recyclable alternative to natural rubber with comparable performance over a wider working temperature range. Moreover, while natural rubber may be more abundant than metals used to synthesize SMAs, as a naturally derived resource, it is at risk of experiencing periodic supply shortages. Further, the vulcanization process may be typically applied to NR to improve its mechanical properties and the mC performance, which can create irreversible crosslinking of polymer chains to form a three-dimensional network. The resulting thermoset material can be biodegradable but cannot be mechanically recycled and thus cannot be easily reintroduced into the rubber industry production cycle.

### Thermodynamic Model for eC and tC Effects in OBC Fibers

The temperature dependence of ΔT in mC effects discussed above can reveal an interplay between deformation and entropy in polymers. It will be appreciated that in the literature, the term “entropy” may be occasionally used to represent the combined effects of enthalpy and entropy for materials undergoing first-order phase transitions, which not only contains the entropic contribution from deformation processes but also includes the enthalpy change associated with phase transitions. The usage of this term can allow for the application of the Helmholtz free energy framework while accounting for phase transitions by subcategorizing the effective entropy into configurational and thermal components. For the purposes of this disclosure, the term “entropy” can strictly measure the degree of disorder or randomness in the system at least because the material does not exhibit first-order phase transitions, thereby adhering to the traditional definition, which accounts for both configurational and conformational contributions.

A unified model for evaluating the deformation-induced entropy change underlying mC effects in elastic polymers is presented below. For example, the mC adiabatic temperature change ΔT can be related to the entropy change ΔS as follows:

$$Δ T = {T}_{0} ( {e}^{- Δ S / C} - 1 ) , \qquad ( 2 )$$

where C=mcₚ is the specific heat of the fiber. The work done to the fiber during a stretching process can be related to the normal stress-strain relation as δW=Vσdϵ, where σ is the stress, ϵ is the strain, and V is the volume of the material. In the absence of first-order phase transitions, the entropy change ΔS in turn can relate to the stretching deformation through the Maxwell relation,

$$Δ S = - \int V \frac{\partial σ}{\partial T} {\vert}_{ϵ} d ϵ . \qquad ( 3 )$$

and with negligible changes in crystallinity observed under deformation, the entropy change rather than phase transitions can dominate the thermodynamics of the process. This situation differs from the previously observed case of natural rubber where a large strain-induced crystallization is observed, or the case of PE where an orthorhombic-to-monoclinic phase transition under shearing stress is reported.

The melt-spun OBC fibers can have crystallinity around 15%, which is significantly lower than that of LDPE (30-50%) and HDPE (80-90%) fibers. The PE-based OBC can have many branched side chains, which introduce steric hindrance that hampers the formation of crystalline structures even under strain. Side chains can also introduce more entanglement, which further prevents polymer chain crystallization. As a result, OBC fibers can be more elastic than PE fibers, making them more non-recoverable, thereby allowing them to exhibit properties similar to NR fibers. The major difference between OBCs and natural rubbers can be the lack of physical cross-linkers, which can make the material thermoplastic and easily recyclable. The elasticity of OBC fibers can originate from the entanglement enabled by branched side chains, and the cross-linker free structure can offer more degrees of freedom for molecular chain relaxation. Unexpectedly, despite being devoid of cross-links, or the substanial absence of cross-links, the fibers of the present embodiments can perform, or even outperform, cross-linked materials such as natural rubber. It will be appreciated that for the purposes of the present disclosure, absence of, or being devoid of, cross-links, or substantial absence of cross-links can refer to a composition being less than about 30 wt % cross-linked, less than about 20% cross-linked, less than about 10 wt % cross-linked, less than about 5 wt % cross-linked, less than about 1 wt % cross-linked, less than about 0.5 wt % cross-linked, or having no cross-links.

The performance of the polymer and its composites can be driven by at least two factors: (i) high entropy change between a random and the oriented chain configurations, which can ensure high elastocaloric temperature changes; and (ii) highly amorphous and elastic nature of the polymer material, which stems, at least in part, from highly-branched soft segments preventing chain crystallization and can enable elastic recovery and cyclic material performance due, at least in part, to the chain entanglement effect. Block copolymers with highly branched soft segments, which can prevent polymer crystallization and maintain elasticity, and no (or low level) of cross-linking, as mentioned above, can ensure that the material exhibits elastic performance and yet remains thermoplastic and can be recycled mechanically, while enabling recyclability, elastic recovery, and/or amorphousness of the material of the present embodiments.

Similar to the stretching process, the work done to the fiber during a twisting process can be conventionally related to the shear stress-strain relation δW=Vτdγ, where τ is the shear stress induced by applied torsional stress, and γ is the shear strain. With the corresponding Maxwell relation, the entropy change can be described by:

$$Δ S = - \int V \frac{\partial τ}{\partial T} {\vert}_{γ} d γ . \qquad ( 3 )$$

However, if an elastic fiber undergoes large enough torque to trigger buckling and the formation of knotting, the torque applied at one end may no longer translate into a shearing stress on the fiber cross-section. Once the fiber buckles into a spiral configuration, the new along-the-fiber direction can become tangential to the original fiber direction, translating the applied torque into an effective tensile stress along the new direction. Based on this observation and the similarity of structural change for twisted and stretched fibers in polarized Raman spectroscopy experiments, a fully-coiled fiber can be equivalent to a fiber being uniaxially stretched with an equivalent elongation ratio.

Generally, as the temperature decreases, a larger force may be needed to achieve the same elongation, which is consistent with the expectations from typical polymer rheology. That is, temperature may increase under deformation and decrease upon release. Moreover, as the ambient temperature decreases, the following trends my be observed: (i) the OBC fibers can exhibit increased brittleness, limiting their maximum elongation; (ii) the force-temperature derivative at a given elongation,

$$\frac{\partial f}{\partial T} {\vert}_{l} ,$$

can increase during both stretch and release processes; and (iii) the hysteresis loop can expand at lower temperatures, leading to a more significant increase in the temperature derivative during the stretch process compared to the release process.

### Optimizing mC Effects in Polymer-Based Materials

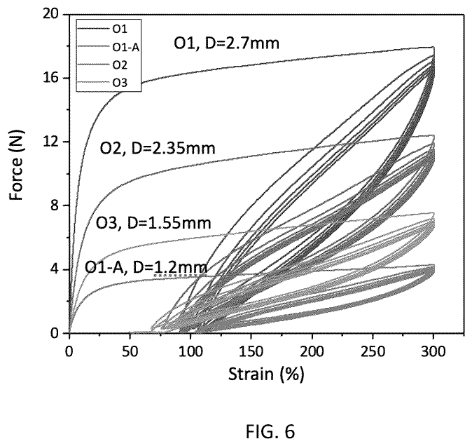

The fibers of the present embodiments can be melt-spun under varying processing conditions. For example, the processing optimization goals can be to: (i) prevent polymer crystallization, (ii) increase the specific heat, and/or (iii) to reduce the area of the hysteresis loop observed during the cyclic mechanical actuation process. The latter can be a measure of the net energy that needs to be provided for the mC effect actuation. In some embodiments, the extrusion temperature can be varied from about 140° C. to about 260° C., and the winding speed can be varied from 0.4 m/in to about 2 m/min. The processing parameters are summarized in Table T1, reproduced below, and the results of their mechanical characterization are shown in FIG. 6. In some embodiments, optimum processing parameters have been identified as follows: extrusion temperature of about 200° C., the screw speed of about 3 m/min, and the winding speed of about 0.4 m/min, though it will be appreciated that one or more of these can be varied.

TABLE T1
OBC elastic fibers fabrication parameters.

| | | | |
|---|---|---|---|
| | Extrusion | | |
| Sample | temperature | Screw speed | Winding speed |

Variation of extrusion temperature

| | | | |
|---|---|---|---|
| O1 | 140 C | | 0.4 m/min |
| O2 | 200 C | 3 | |
| O3 | 260 C | | |

Variation of drawing ratio

| | | | |
|---|---|---|---|
| O1-A | 140 C | 3 | 2.0 m/min |
| O2-A | 200 C | 3 | 2.0 m/min |

The operational scenarios (i.e., parameters of the cyclic loading process) can be optimized to achieve the highest mC performance of elastic amorphous fibers, with greater than 90% of the fiber being in the amorphous phase and/or 100% of the fiber being amorphous in some embodiments. Some non-limiting examples of these can include: draw ratio, twist density, speed of mechanical actuation, the largest allowed deformation, the level of pre-stretch applied to the fiber before twisting actuation is applied, etc.

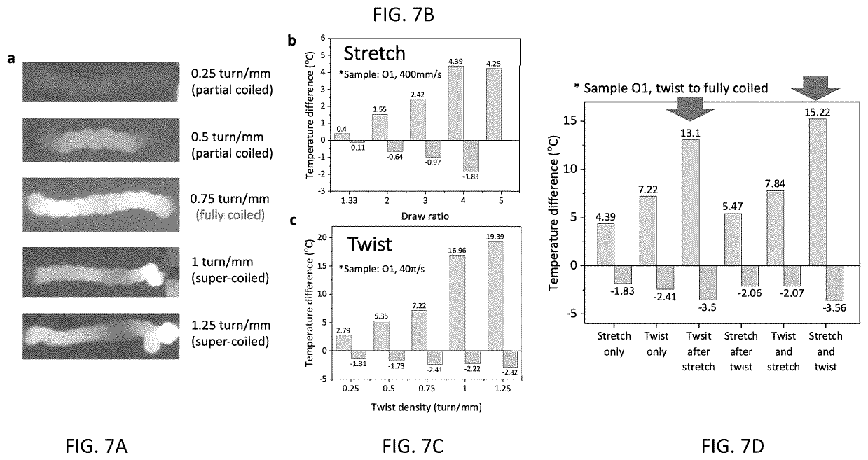

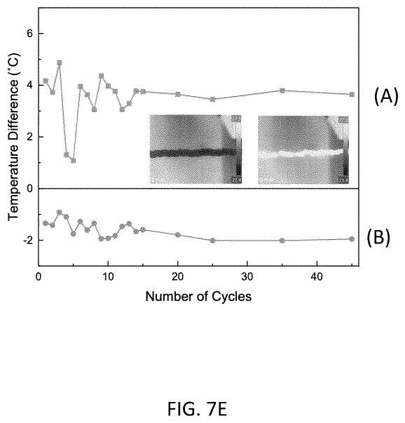

FIGS. 7A-7D illustrate the results of the optimization of the operational parameters discussed above. For example, as shown in FIG. 7A, for deformation levels ranging from 0.25turn/mm to 1.25 turn/mm, the fiber of the present embodiments can increase in temperature with increased coiling. Moreover, as shown in FIGS. 7B-7C, graphs of the heating and cooling temperatures achieved by each of uniaxial stretching to a different draw ratio (FIG. 7B) and fiber twisting processes with varying twisting density (FIG. 7C) shows an increase in temperature difference under both scenarios. Specifically, under uniaxial stretching of FIG. 7B, a gradual increase occurs with increased twisting, with a slight decrease for the 1.25 turn/mm deformation. For FIG. 7C, a dramatic increase in temperature difference is observed when varying twist density, especially for the 1 turn/mm and the 1.25 turn/mm variations. When comparing the various operational scenarios of present embodiments, the two most optimum scenarios are identified to be (i) twist after stretch and (ii) simultaneous twist and stretch, as shown in FIG. 7D. Larger-scale structural engineered features, such as fiber plying, braiding, and/or knotting (as shown in FIG. 1B above) can improve the material performance and fatigue resistance. Moreover, FIG. 7E illustrates that a braided structure can have higher temperature differences under stretching deformation in both heating (A) and cooling performance (B) than an individual fiber 1 either under stretching or twisting/stretching deformations.

Despite the demonstrations of high material cost of performance (COP) in mC polymers, solid-state heating/cooling applications can demand further engineering and optimization of elastic polymer materials and mC systems. In some embodiments, OBC fibers can be used to either heat or cool water, with the mechanism governing mC effects in polymers helping to design and optimize their performance. In OBC fibers, for example, mC effects can be driven by the entropy change caused by molecular chain alignment under strain, which is different from cross-linked polymers where a strain-induced crystallization-associated latent heat dominates the process. For mC polymers without phase change, an ideal mC polymer candidate likely should have a large stress-temperature derivative around the working temperature. Accordingly, eC material candidates can be initially screened by their Young's modulus temperature derivative values. Although large strain can deform a polymer beyond the elastic regime, a Young's modulus temperature derivative can still be a good figure of merit to search for materials with a large entropy change. That is, for composites undergoing a large entropy change, a strong temperature dependence of the Young's modulus of the material can be observed.

Moreover, mC performance of elastic thermoplastic cross-linker-free OBC fibers can suffer a fast drop during initial loading cycles due to large irreversible plastic deformations of the material. Further, polymer chains relaxation under strain can lead to the observed strain-stress hysteresis, thereby reducing the cooling COP. The material performance can be further tuned through chemically engineering the molecular composition and by introducing a controllable level of cross-links to find an optimum balance between high COP, large temperature range, fatigue resistance, and/or recyclability. It is likely that by synergistically optimizing material intrinsic mechanical properties and fiber/system geometry, a polymer-based mC device can be designed that fits in a variety of thermal applications with zero carbon footprint.

### Evaluation and Prediction of Elastocaloric (EC) Performance of Amorphous Polymers Via Density Functional Theory (DFT)

In some embodiments, modeling can be used to evaluate the entropy change, ΔS, of a single linear polymer chain as it transforms under applied uniaxial stress from a fully relaxed entangled random configuration to an untangled stretched configuration with fixed chain ends. The model assumptions include: (i) the polymer backbone chemistry plays a significant role in the entropy change, (ii) entanglements with other chains are excluded from simulations, and (iii) chain branching and cross-linking are not included into the model.

The temperature change in the polymer (ΔT) under such configurational change can be calculated as follows:

$$Δ T = {T}_{0} ( {e}^{\frac{- Δ S}{C}} - 1 ) \approx {T}_{0} \frac{- Δ S}{C} ,$$

where ΔS is the entropy change, C is the specific heat, and T₀ is the initial temperature. The above equation assumes that the change in entropy is small to linearize the exponential.

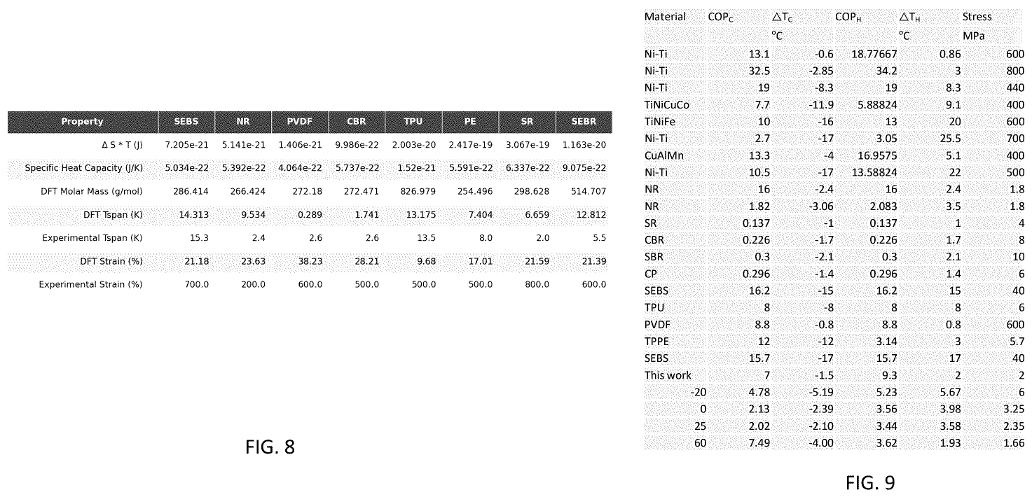

ΔT can then be calculated for unstrained and strained polymers. For the known amorphous eC polymers, the calculated value can be compared to the corresponding experimental value reported in prior literature. When applied to a single chain of amorphous polyethylene, the model predicts ΔT=7.4K, indicating high potential of this polymer as an elastocaloric material. The experimental testing (at the same fiber elongation ratio) produced ΔT=8K, thereby confirming this potential for use as elastocaloric material. The results are summarized in FIG. 8, which compares various polymer types (i.e., (1) styrene ethylene butylene styrene (SEBS) (C₈H₈)ₙ—(C₆H₁₂)ₘ—(C₈H₈)ₙ, (2) natural rubber (NR) (C₅H₈)ₙ, (3) cis-butadiene rubber (CBR) (C₄H₆)ₙ, (4) thermoplastic polyurethane (TPU) [—OC(O)—R—NH—C(O)—O—R′—O—]ₙ, and (5) olefin block copolymer (OBC) and their corresponding heating ΔT values under uniaxial stretching deformation.

As a result of the above, the chemical composition of each individual chain of polymer can be used to provide the largest entropy change between its fully relaxed (random) configuration and the fully extended (linear) configuration. In some embodiments, a mechanocaloric temperature change of the material between its fully relaxed configuration and its fully deformed configuration can be approximately in a range from about 1.5° C. to about 30° C. It will be appreciated that SEBS is a triblock copolymer composed of ethylene-butylene with styrene on either side, which lacks side-chains and crosslinking. The value for natural rubber is taken at about 200% strain, before strain-induced crystallization would be triggered and contribute to the total measured ΔT value. This crystallization component is neglected since it is not included in the model. CBR has both hard chains and soft side chains, and for the present disclosure in DFT, no side chains are considered, only the polybutadiene backbone. TPU has alternating hard and soft segments, which are accounted for in the calculations. Moreover, the DFT values model a single polymer strand with no entanglements with other polymers at the environmental temperature of 298.15 K. The experimental polymer values are reported after the very first stretch and do no account for the material cyclic training, which is often needed to stabilize the change in temperature after the initial irreversible deformation in the material happens during the first few cycles. The specific heat can be calculated via DFT for the unstrained polymer configuration.

### Methods

The elastic fibers are melt-spun from olefin block copolymer by using a single-screw extruder (Filabot) with the extrusion temperature of about 200° C., the screw speed of about 3 m/min, and the winding speed of about 0.4 m/min.

The mechanical stretching/twisting stage is designed by SUSTech and assembled by Avatar Intelligent Equipment (Shenzhen) Co., Ltd. Fibers are fixed on both ends by jaw clamps, with one end attached to the endplate and the other-to the sliding stage on the guiding rail. A hybrid stepping motor moves the sliding stage along the rail, subjecting the fiber to a controlled uniaxial strain. A servo motor is connected to the moving clamp, enabling twisting deformation with a controllable number of turns and twisting speed. Either a force sensor (DYLY-103-10 KG, CALT) or a torque gauge (MTT03-10Z, Mark 10) can be mounted in place of the clamps to measure the in-situ force/torque during the deformation process. To ensure that the mC effect measurement process is adiabatic, deformation at high strain rates can be performed to minimize the convection heat transfer between the sample and the ambient environment. Unless otherwise stated, the rate of twist insertion and twist removal is about 40 turns/s, and the rate of stretching and release is about 400 mm/s.

In-situ temperature responses during the fiber adiabatic deformation process are measured by using an automated mechanical stretching/twisting stage equipped with an infrared (IR) camera 104, as discussed above. The IR camera (FLIR ETS320) with a 320×240 IR sensor captures temperature data from 76,800 pixels at the speed of about about 9 frames per second. The average and the maximum surface temperature changes are recorded along a software-generated fiber centerline. A home-built temperature-controlled chamber (which consists of thermoelectric units and a cooling tower) encloses the fiber and enables a twistocaloric effect to be characterized in a wide temperature range, from about −20° C. to about 60° C.

During testing, elastocaloric OBC fibers can be melt-spun and/or doped with a variety of organic and inorganic dopants that are added during the spinning process. The polymers can be doped and/or decorated by PCM nanomaterials, including paraffins, liquid crystals, liquid metals, magnetocaloric materials (such as e.g., gadolinium micro/nano-particles), electrocaloric materials (such as e.g., perovskites, thermochromic pigments and dyes), metal organic frameworks (MOFs), etc. In some embodiments, a thermochromic powder can be embedded during the spinning process, and upon actuation by uniaxial stretching, the fiber 110 can heat up, and this temperature increase can trigger visible color of the fiber change owing to the temperature-induced phase transition in the thermochromic pigment. For example, as shown in FIGS. 11A-11B below, a visible color change may occur, e.g., from dark blue to light blue, though the colors can vary, in a thermochromic pigment embedded into a polymer fiber during the melt-spinning process. The color change can be induced by the stretch-induced heating effect in an OBC elastocaloric fiber when it transitions from its unstretched, or pristine state 1a, to its stretched state 1b. Once the fiber 110 cools down to the room temperature, the color can change again, reverting to the original shade of blue once the reverse phase transition of the thermochromic powder is complete.

Fiber crystallinity and Herman's orientation factor are determined using a SAXSLAB small-angle X-ray scattering system equipped with a Riga 002 microfocus X-ray source and Osmic staggered parabolic multi-layer optics. A DECTRIS PILATUS 300K detector is used to record the 2D X-ray scattering patterns.

Polymer chain orientation is also characterized via the polarized Raman spectroscopy by using a Renishaw Invia Reflex Raman Confocal Microscope equipped with a computer-guided linear polarizer and a 532 nm laser source. 3D Raman maps are captured with a WITec alpha 300 apyron Confocal Raman system using a 532 nm laser.

Fiber tensile testing is performed on a Zwick BTC-EXMACRO.001 mechanical tester with a built-in temperature-controlled chamber. Infrared absorption properties of the fibers are characterized via Fourier-Transform Infrared Spectroscopy (FTIR). The specific heat capacity of the fiber material is measured using a differential scanning calorimeter (DSC 2500 from TA Instruments). A segment from each sample is sliced off and sealed inside Tzero Aluminum Hermetic pans. The heat flow rate is measured from −40° C. to 180° C. with heating and cooling rates of 10° C./min and nitrogen flow rate of 50 mL/min.

Examples of the above-described embodiments can include the following:
1. A process for forming a composite, comprising:
   melt spinning a plurality of materials, the plurality of materials being at least one of elastocaloric or twistocaloric; and
   performing a combination of one or more of twisting, braiding, knotting, or stretching deformations of the plurality of materials to produce a composite configured to have reversible temperature shifts stored therein.
2. The process of claim 1, wherein the plurality of materials comprises one or more olefin block co-polymers.
3. The process of claim 1 or claim 2, further comprising cross-linking the plurality of materials by irradiation with one or more of electron beams, X-rays, or gamma-rays.
4. The process of any of claims 1 to 3, further comprising coupling one or more phase change materials to the plurality of materials.
5. The process of any of claims 1 to 4, wherein coupling one or more phase change materials to the plurality of materials further comprises doping the plurality of materials with one or more phase change materials.
6. The process of any of claims 1 to 5, wherein coupling one or more phase change materials to the plurality of materials further comprises directly attaching the one or more phase change materials to the plurality of materials.
7. The process of any of claims 1 to 6, wherein the plurality of materials comprises one or more amorphous co-polymers or substantially amorphous co-polymers.
8. The process of any of claims 1 to 6, wherein the composite material is at least one of environmentally friendly or sustainable.
9. The process of any of claims 1 to 8, wherein an activation energy for forming the composite material is at least one order of magnitude lower than a known activation energy for forming comparable composite materials that lack the plurality of materials.
10. The process of any of claims 1 to 9, wherein performing the combination of one or more of twisting, braiding, knotting, or stretching deformations of the plurality of materials to produce a composite material configured to have reversible temperature shifts stored therein further comprises adjusting at least one of: a speed of deformation, a number of times a deformation is performed, a temperature, a type of deformation, or a level of deformation to alter properties of the resulting composite material.
11. The process of any of claims 1 to 10, wherein the process is devoid of strain-induced crystallization.
12. The process of any of claims 1 to 11, further comprising adding a dopant to the plurality of materials.
13. The process of claim 12, wherein adding the dopant further comprises spin-doping the material with one or more magnetocaloric or electrocaloric materials.
14. The process of claim 12 or claim 13, wherein the dopant further comprises at least one of nano-scale phase-separated inclusions or micro-scale phase-separated inclusions in a matrix of the plurality of materials.
15. The process of any of claims 1 to 2 or 6 to 14, wherein the the plurality of materials are substantially devoid of cross-links.
16. A method of providing at least one of energy conversion or energy storage, comprising:
   using a composite material comprised of a plurality of melt-spun materials that are at least one of elastocaloric or twistocaloric, and underwent at least one of twisting or stretching deformations, in conjunction with at least one of a heat pump, a refrigeration system, a rechargeable hot-cold bandage, or a blanket.
17. The method of claim 16, wherein the composite material is at least one of a fiber or yarn, at least one of the at least one of the fiber or yarn having a phase-change material coupled thereto.
18. A composite, comprising:
   a thermoplastic block co-polymer having a plurality of at least one of melt-spun elastocaloric or twistocaloric materials that have reversible temperature shifts stored therein after a combination of at least one of twisting or stretching deformations of the at least one of melt-spun elastocaloric or twistocaloric materials.
19. The composite of claim 18, wherein the composite is substantially devoid of cross-links.
20. The composite of claim 18 or claim 19, wherein the thermoplastic block co-polymer comprises one or more olefin block co-polymers.
21. The composite of any of claims 18 to 20, wherein at least 90 wt % of the thermoplastic block co-polymer is in amorphous phase.
22. The composite of any of claims 18 to 21, wherein a mechanocaloric temperature change of the material between its fully relaxed configuration and its fully deformed configuration is approximately in a range from about 1.5° C. to about 30° C.
23. The composite of any of claims 18 to 22, wherein a Young's Modulus of the material depends on a temperature in which the thermoplastic block co-polymer is disposed.
24. The composite of any of claims 18 to 23, wherein the thermoplastic block co-polymer has a glass transition temperature approximately in a range of about 0° C. to about −30° C.
25. The composite of any of claims 18 to 24, further comprising at least one of nano-scale phase-separated inclusions or micro-scale phase-separated inclusions in a matrix of the thermoplastic block co-polymer.

One skilled in the art will appreciate further features and advantages of the disclosure based on the above-described embodiments. Accordingly, the disclosure is not to be limited by what has been particularly shown and described, except as indicated by the appended claims. All publications and references cited herein are expressly incorporated herein by reference in their entirety.

Some non-limiting claims are provided below.

What is claimed is:

1. A process for forming a composite, comprising:
melt spinning a plurality of materials, the plurality of materials being at least one of elastocaloric or twistocaloric; and
performing a combination of one or more of twisting, braiding, knotting, or stretching deformations of the plurality of materials to produce a composite configured to have reversible temperature shifts stored therein.

2. The process of claim 1, wherein the plurality of materials comprises one or more olefin block co-polymers.

3. The process of claim 1, further comprising cross-linking the plurality of materials by irradiation with one or more of electron beams, X-rays, or gamma-rays.

4. The process of claim 1, further comprising coupling one or more phase change materials to the plurality of materials.

5. The process of claim 1, wherein coupling one or more phase change materials to the plurality of materials further comprises doping the plurality of materials with one or more phase change materials.

6. The process of claim 1, wherein the plurality of materials comprises one or more amorphous co-polymers or substantially amorphous co-polymers.

7. The process of claim 1, wherein an activation energy for forming the composite material is at least one order of magnitude lower than a known activation energy for forming comparable composite materials that lack the plurality of materials.

8. The process of claim 1, wherein performing the combination of one or more of twisting, braiding, knotting, or stretching deformations of the plurality of materials to produce a composite material configured to have reversible temperature shifts stored therein further comprises adjusting at least one of: a speed of deformation, a number of times a deformation is performed, a temperature, a type of deformation, or a level of deformation to alter properties of the resulting composite material.

9. The process of claim 8, further comprising adding a dopant to the plurality of materials.

10. The process of claim 9, wherein adding the dopant further comprises spin-doping the material with one or more magnetocaloric or electrocaloric materials.

11. The process of claim 9, wherein the dopant further comprises at least one of nano-scale phase-separated inclusions or micro-scale phase-separated inclusions in a matrix of the plurality of materials.

12. The process of claim 1, wherein the the plurality of materials are substantially devoid of cross-links.

13. A method of providing at least one of energy conversion or energy storage, comprising:
using a composite material comprised of a plurality of melt-spun materials that are at least one of elastocaloric or twistocaloric, and underwent at least one of twisting or stretching deformations, in conjunction with at least one of a heat pump, a refrigeration system, a rechargeable hot-cold bandage, or a blanket.

14. The method of claim 13, wherein the composite material is at least one of a fiber or yarn, at least one of the at least one of the fiber or yarn having a phase-change material coupled thereto.

15. A composite, comprising:
a thermoplastic block co-polymer having a plurality of at least one of melt-spun elastocaloric or twistocaloric materials that have reversible temperature shifts stored therein after a combination of at least one of twisting or stretching deformations of the at least one of melt-spun elastocaloric or twistocaloric materials.

16. The composite of claim 15, wherein the composite is substantially devoid of cross-links.

17. The composite of claim 15, wherein at least 90 wt % of the thermoplastic block co-polymer is in amorphous phase.

18. The composite of claim 15, wherein a Young's Modulus of the material depends on a temperature in which the thermoplastic block co-polymer is disposed.

19. The composite of claim 15, wherein a mechanocaloric temperature change of the material between its fully relaxed configuration and its fully deformed configuration is approximately in a range from about 1.5° C. to about 30° C.

20. The composite of claim 15, further comprising at least one of nano-scale phase-separated inclusions or micro-scale phase-separated inclusions in a matrix of the thermoplastic block co-polymer.
